(19) United States
(12) Patent Application Publication
(10) Pub. No.: US 2023/0080929 A1
(43) Pub. Date: Mar. 16, 2023

(54) SYSTEMS AND METHODS FOR CONNECTING SERVICE PROVIDERS TO CLIENTS

(71) Applicant: Ella H. LIN, Newport Beach, CA (US)

(72) Inventor: Ella H. LIN, Newport Beach, CA (US)

(21) Appl. No.: 17/760,447

(22) PCT Filed: Mar. 2, 2021
(86) PCT No.: PCT/US21/70217

§ 371 Date: Aug. 9, 2022

Related U.S. Application Data
(60) Provisional application No. 62/984,452, filed on Mar. 3, 2020.

(51) Int. Cl. G06Q 30/02; G06Q 30/06

(52) U.S. Cl. CPC G06Q 30/0282; G06Q 30/0609; G06Q 30/0631

(57) ABSTRACT

A computer-implemented system and method for connecting clients with service providers is described herein. The system uses explainable artificial intelligence (XAI) to match clients and service providers, minimizing system bias. In addition to matching clients with service providers, the system also has tools for background checks, payment, scheduling, and goal setting.

### CROSS-REFERENCE TO RELATED APPLICATIONS

This application claims the benefit of U.S. Provisional Application No. 62/984,452 filed on Mar. 3, 2020, which is incorporated herein by reference in its entirety.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### FIELD

The present teachings relate to systems and methods for connecting clients and service providers while continuously improving the matching of clients with service providers.

### INTRODUCTION

Clients who need service providers to provide services, such as elderly care or working clients who need assistance with personal services such as house cleaning, shopping, babysitting, tutoring, pet care, and the like, often have difficulty finding suitable service providers. Similarly, service providers often have difficulty effectively marketing their services.

There is a need for a system and method that connects service providers with clients. Such a system would provide service providers ratings and facilitate interviews between clients and service provider candidates. To make communication between the client and service provider easier, the system operates over networked computing devices, such as smartphones, computers, or the like. To make matching clients and service providers even more accurate, the system must be trainable, accumulating data continuously to provide better matches.

### SUMMARY

The present teachings include a computer-implemented system for matching at least one client with at least one service provider comprising a terminal for receiving input data further comprising a processor, a memory, a database module, a network module, an engine for data processing comprising a machine learning process that is trained to match the at least one client and the at least one service provider, an explainable model that minimizes bias of the machine learning process, and an explanation interface that shows output data comprising results of the machine learning process after application of the explainable model, offering a recommendation for matching the at least one client with the at least one provider. The explainable interface may be the same as a user interface of a networked computing device, such as a smartphone, computer, and the like. Networked computing devices are used by both clients and service providers to communicate with each other. The system may be implemented with a variety of platforms, one of which is AWS, with Snowflake as a cloud-based Data Warehouse solution.

In accordance with a further aspect, the network module connects a computing device associated with the at least one client and a computing device associated with the at least one service provider. The network module makes it possible for a client to communicate with a service provider. The client and service provider communicate once they are matched.

In accordance with yet another aspect, the machine learning process accepts input data from a client questionnaire. The client questionnaire has questions that the machine learning process is trained to analyze to arrive at service provider suggestions for the client. As more questionnaire data is acquired, the accuracy of the matching between the clients and service providers improves.

In accordance with yet a further aspect, output data is at least one service provider based on the input data and application of the explainable model to the machine learning process, with data associated with the at least one service provider being sent to the at least one client. The system sends the service provider recommendations to the client and is viewable by the client on a user interface of the client's networked device.

In accordance with yet another aspect, a match between the at least one client and the at least one service provider is gauged between 0% and 100%, with the match being a prediction of the machine learning process after application of the explainable model. Lower percentages indicate a poor match between the client and the service provider, and a higher percentage indicates a better match. In an embodiment, there is a threshold to the percentages that triggers a need for a user like the client to adjust the input data, such as the answers to the questionnaire. In this embodiment, less than 50% match leads to such an adjustment. In another embodiment, less than 40% match leads to such an adjustment. In yet another embodiment, less than a 30% match leads to such an adjustment.

In accordance with yet another aspect, the match is adjustable by feedback from a user. A user, typically the client, may adjust the match by modifying answers to the questionnaire or modifying other input or training data. Service providers may also adjust factors such as their rate and their availability times with the system.

In accordance with yet another aspect, the system further comprises a background check tool. The system is capable of initiating background checks of service providers for the clients' benefit. As more data associated with the service providers is accumulated, better background checks are possible.

In accordance with yet another aspect, the system comprises an interviewing tool. With this tool, the client is able to provide feedback as is the service provider. As inputted data regarding the service provider is collected, it is possible to either improve or lessen the rating of the service providers, or provide certification and training options to the service providers.

In accordance with yet another aspect, the system comprises a payment tool. The payment tool summarizes the service providers' total hourly pay and hours work in a spreadsheet and exports to a client's payroll provider based. Examples of the payroll provider are ADP and Paychex, although any payroll provider is acceptable. The payment tool also tracks total gross pay that clients should have for budgeting purposes.

In accordance with yet another aspect, the system comprises at least one of scheduling tool, a communications tool, and a texting tool. It is possible for the system to schedule appointments for the service providers with the clients. In addition, communication between the service providers and the clients is possible. In an embodiment, communication is via text. In another embodiment, communication is via email. In yet another embodiment, communication is via messenger. In yet another embodiment, communication is via video. In yet another embodiment, communication is via text, email, video, and messenger.

In accordance with yet another aspect, the system comprises at least one of a goal setting tool and a budget tool. The goal setting tool sets expectations and possible rewards for the service providers. For instance, if the service provider performs the client's task by a particular date, there is a potential reward that the service provider can receive. The system may create an activities report to keep track of the work that the service provider has done and the work that has yet to be completed. The activity report may also track work that is done in relation to work that should have been done up to that point. In an embodiment, the activity report tracks activities daily. In another embodiment, the activity report tracks activities weekly. In yet another embodiment, the activity report tracks activities monthly. In yet another embodiment, the activity report tracks activities yearly. In yet another embodiment, the activity report may track activities daily, weekly, monthly, and yearly. If there are milestone payments that the service provider receives once certain work is completed, the system is capable of recording the dates of those payments to remind the client to pay. The budget tool allows the client to allocate a certain amount of funds for various tasks, and the value of the service provider's work is deducted from those funds. In the event that the service provider is rejected, feedback on training and certification suggestions are provided to the service provider.

The present teachings also include a method for matching at least one client with at least one service provider comprising: providing a system that comprises a terminal for accepting input data further comprising a processor, a memory, a database module, a network module, an engine for data processing comprising a machine learning process that is trained to match the at least one client and the at least one service provider, an explainable model that minimizes bias of the machine learning process, and an explanation interface that shows output data comprising results of the machine learning process after application of the explainable model, offering a recommendation for matching the at least one client with the at least one provider; inputting input data from the at least one client; receiving a match with at least one service provider; and refining the match based on further training of the input data. The input data is training data the machine learning process accepts to return service provider recommendations. The explainable model is applied to the results of the machine learning process to allow the user to assess how useful the results are, and the explanation interface may be a user interface of the client's or service provider's networked computing device. The method allows the continuous refinement of recommendations of service providers to the client by more and more input data going into the system and being trained by the system.

In accordance with a further aspect, the data is information from a client questionnaire.

In accordance with yet another aspect, the network module connects a computing device associated with the at least one client and a computing device associated with the at least one service provider.

In accordance with yet another aspect, the match between the at least one client and the at least one service provider is gauged between 0% and 100%, with the match being a prediction of the machine learning process after application of the explainable model.

In accordance with yet another aspect, the match is adjustable by feedback from a user.

In accordance with yet another aspect, further comprising a background check tool.

In accordance with yet another aspect, further comprising an interviewing tool.

In accordance with yet another aspect, further comprising a payment tool.

In accordance with yet another aspect, further comprising at least one of scheduling tool, a communications tool, and a texting tool.

In accordance with yet another aspect, further comprising at least one of a goal setting tool and a budget tool.

These and other features, aspects and advantages of the present teachings will become better understood with reference to the following description, examples and appended claims.

### DRAWINGS

Those of skill in the art will understand that the drawings, described below, are for illustrative purposes only. The drawings are not intended to limit the scope of the present teachings in any way.

FIG. 1. A diagram of the manner in clients connect with service providers via networked computing devices.

FIG. 2. Flowchart of the matching process.

FIG. 3. Flowchart showing steps for registered service providers.

FIG. 4. Schematic illustrating explainable artificial intelligence (XAI).

FIG. 5. Depiction of a user interface from a client's networked computing device.

FIG. 6. Another depiction of a user interface.

FIG. 7. Depiction of clickable buttons and a clickable calendar.

FIG. 8. Depiction of a calendar detail.

FIG. 9. Depiction of an activity report.

### DETAILED DESCRIPTION

Abbreviations and Definitions

To facilitate understanding of the invention, a number of terms and abbreviations as used herein are defined below as follows:

Trained: As used herein, the term “trained” refers to having been taught a particular skill or type of behavior through practice and instruction over a period of time.

Explainable artificial intelligence (XAI): As used herein, the term “XAI” refers to artificial intelligence that minimizes bias by users understanding why the algorithm makes decisions or predictions, ensuring that the results the algorithm produces are justifiable.

Systems and Methods for Connecting Service Providers to Clients

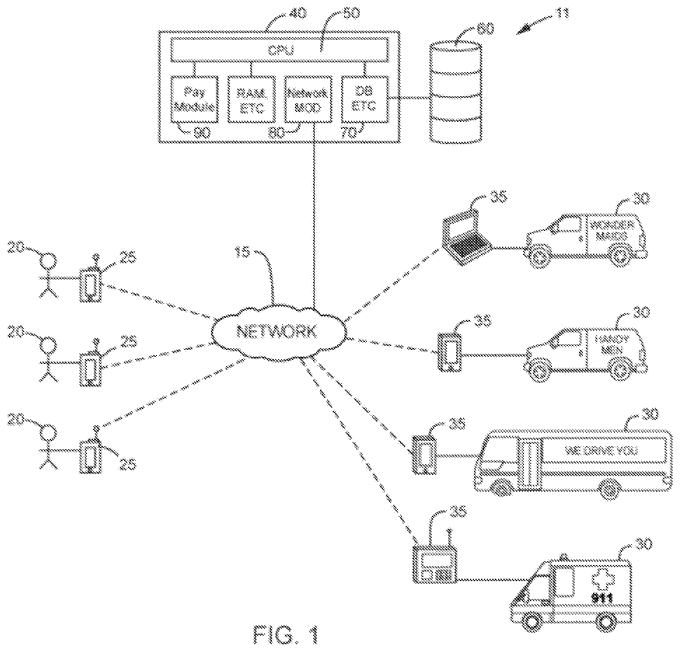

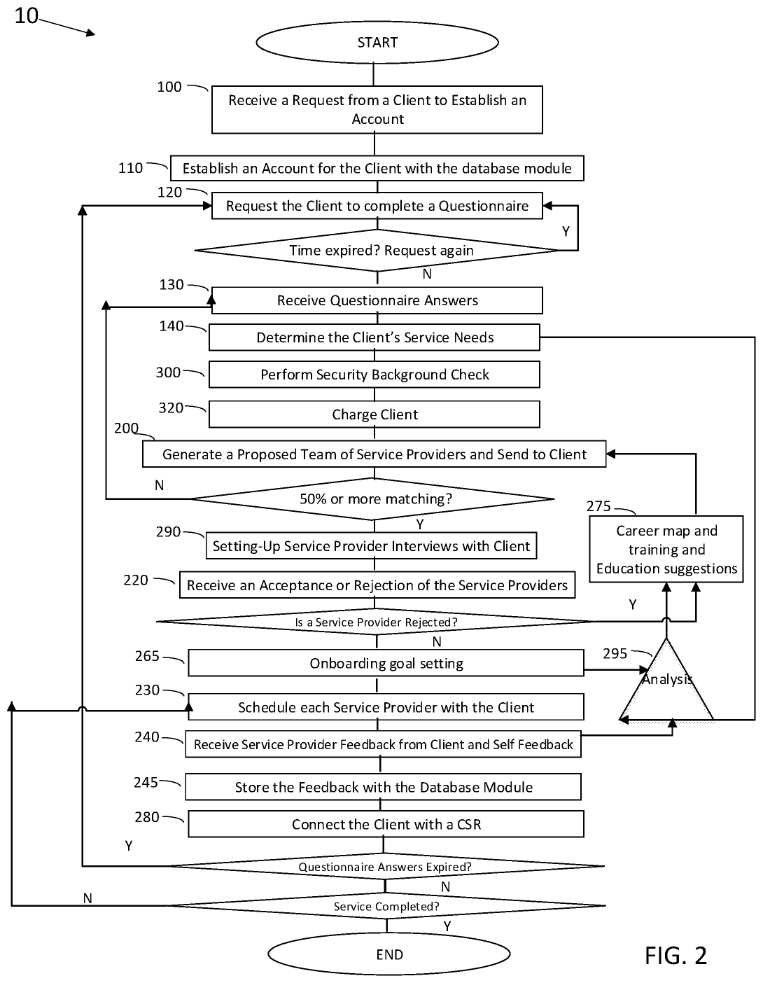

The present invention is directed to a computer-implemented system for connecting service clients to clients in such a way that certain aspects of the matching process may be refined with increased data inputted into system. FIGS. 1 and 2 illustrates a method 10 and system 11 for implementing the method 10. The method 10 connects services providers 30 having service provider networked devices 35 with clients 20, having client networked devices 25. Communication between the clients 20 and the service providers 30 happens at least partially over a network 15, such as the Internet, mobile networks, or the like. Client networked devices 25 and service provider networked devices may take on many forms, such as smartphones, computers, and the like.

The system 11 (FIG. 1) includes a server 40 that has at a minimum a processor 50, a non-volatile memory 60, a database module 70, and a network module 80 adapted for communicating with the clients 20 and the service providers 30 through the network 15. Clearly such a server 40 may be a plurality of servers 40 all running in concert to provide the system 11, either at a common location, distributed through a geographic region, or distributed worldwide, provided all the servers 40 are connected through a network 15.

The method 10 includes at least the steps outlined in FIG. 2. The server 40 receives a request 100 through the network 15 from one of the clients 20 to establish an account. An account sign-up page (not shown) can be displayed by the server 40 to potential clients, which may obtain the sign-up page through any suitable form of marketing such as banner ads, pay-per-click ads, traditional newspaper or magazine advertisements, or the like. In addition, the client 20 may visit a website associated with the system 11 and, after inputting requested information to a sign-up page on the website, this information may be used as input data to the system 11 to be collected in a customer relationship management (CRM) platform.

In some embodiments, the system 11 charges the client 20 a predetermined fee 320 through a payment module 90 for establishes the account and/or requesting services. Alternately, or additionally, the system 11 charges the client 20 a predetermined percentage of any fees charged by the service providers 30.

Once the system 11 receives the request 100, the server 40 then established the account 110 for the client 20 with the database module 70. Such an account 28 may include contact information of the client 20, such as name, residential and mailing addresses, phone numbers, email addresses, and the like.

Initially the server 40 sends a request 120 to the client 20 to complete a questionnaire. The questionnaire may be sent after establishing the account or concurrently therewith at the sign-up pages, If a predetermined period of time, such as one week, expires without receiving the questionnaire answers from the client 20, the server 40 sends a subsequent request 250 again to the client 20 to complete a questionnaire. This may repeat a number of times, such as three times, before the system deactivates the client's account, for example.

When the server 40 receives questionnaire answers 130 from the client 20, such answers are stored with the database module 70. The server 40 then determines 140 the client's service needs based on the questionnaire answers received. The questionnaire may ask the client for information pertaining to, for example, the client's home environment for determining safety vulnerabilities, the client's established insurance accounts, the client's financial accounts and the frequency of the client's access thereof, health and medical records, current doctors, treatments and prescriptions, physical needs such as physical therapy, requirements and amount of physical activity that the client engages in, personality and temperament assessments, the client's gender, language, religious affiliation, and other cultural assessments, food and entertainment preferences, familial relationships and proximity of immediate and extended family, work and educational history, and the like. Determining client's needs 140 may be carried out via analysis 295 of the needs of the client 20

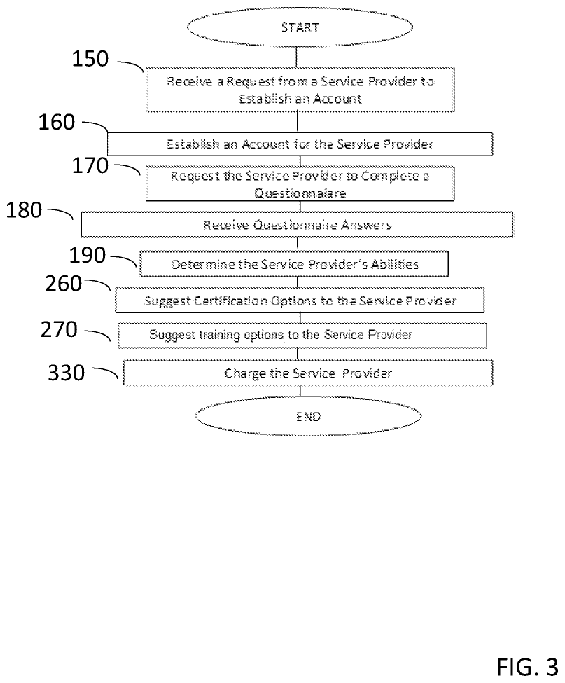

Meanwhile, the server 40 also simultaneously can receive requests 150 (FIG. 3) through the network 15 from service providers 30 to establish a service provider account. The server 40 then establishes 160 the account for the service provider 30 with the databased module 70 and requests 170 the service provider to complete a service provider questionnaire.

Once the server 40 receives 180 questionnaire answers from the service provider 30, it stores such answers with the database module 70 and determines 190 abilities of the service provider 30 based on the questionnaire answers received. Such a service provider questionnaire 170 may request information pertaining to the service provider's location, type of work preferred, routine changes for such work, availability, preferred payment methods, qualification information such as education, licenses, certifications, and the like, physical abilities, technical skills, gender, language, religious affiliation, interests, personality and temperament assessments, and the like.

In some embodiments, if one of the service providers 30 needs certification for an ability but does not have the certification, the server 40 suggests certification options 260 to the service provider 30. For example, if a service provider 30 needs a certification to obtain and deliver medications to the client 20, the system 11 suggests to the service provider 30 who has a skill at driving to obtain such a certification by providing a list of certification providers (not shown).

Similarly, if a service provider 30 needs training 70 for an ability that he could otherwise provide to the client 20, but does not have the training, the server 40 suggests training options 270 to the service provider 30. For example, a service provider 30 who normally provides house sitting services might be offered training for pet care to augment his abilities. In some embodiments, the server 40 charges the service provider 30 a predetermined fee 330 for establishing the account in order to offer services to the clients 20, or alternately charges a predetermined percentage of any fees collected by the service providers 30 from the clients 20, such as 3% to 10%, for example.

In some embodiments, if there are not enough service providers 30 to meet most or all of the needs of any one particular client 20, the system 11 waits for additional service providers 30 until each service need of the client 20 is able to be met by at least one of the service providers 30.

The system 11 then generates a proposed team 200 of service providers 30 to meet the needs of the client 20, typically by comparing the abilities of the service providers 30 with the needs of the clients 20, the proximity between the service providers 30 and the clients 20, and ranking similar questionnaire answers of the clients 20 with the questionnaire answers of the service providers 30. The system 11 sends information about the proposed team of service providers 30 to the client 20 along with at least a portion of the questionnaire answer received by each service provider 30. For example, political and religious affiliations, interests, background information, and home town information of the service providers 30 may be displayed to the client 20 for promoting matches between like-minded clients 20 and service providers 30.

In some embodiments of the system 11, upon request by the client 20 after receiving the proposed team of service providers 30, the system 11 sets up 290 either in-person or video interview with any of the service providers 30 on the proposed team and the client 20. Such an interview 290 may be conducted through a web cam system such as Skype or Zoom, or in person by scheduling an interview 290 time between the service provider 30 and the client 20 at a predetermined location, such as the client's residence. Whether an interview is set up is dependent on the match between the client 20 and the service provider 30. The system 11 is trained to improve matches as the bank of answers to the questionnaire increases. If the match is less than 50%, the system does not move forward but reverts back to the questionnaire answers. If the matching percentage is 50% or greater, the system 11 proceeds forward.

The system 11 then receives an acceptance or rejection of the service providers 30 on the proposed team by the client 20 and, if a rejection, replaces objectionable service providers 30 with alternate service providers 30 until the client 20 is satisfied, perhaps with the next most highest ranked service provider 30 out of all the service providers 30 in the database module 70.

In the event that the service provider 30 is accepted, onboarding 265 takes place whereby goals are set for the service provider 30 by the client 20. If the service provider 30 is rejected or is unable to meet the needs of the client 20, analysis 295 of these needs prompts feedback 275 on potential education and/or certification recommendations are provided to the service provider 30.

The system 11 then schedules 230 each service provider 30 with the client 20 to provide the needed services on the client's networked device 25 and presents times thereon for the client 20 to select for each needed service provided by the service providers 30 on the team 200 of service providers 30. Preferably each service need has three or more potential service providers 30 in the database module 70 that can be matched with the client 20, particularly if an assigned service provider 30 is for some reason unable to keep a scheduled meeting time.

During performance of the needed services by any of the service providers 30 on the team of service providers 30, if the clients appears ill to the service provider 30, and if the client's questionnaire answers include emergency medical contact information, the system 11 prompts the service provider 30 to contact emergency services such as 911, health care workers, or the like. For example, if the client 20 faints or requires medical attention, the service provider 30 can quickly utilizer his network connected device 35 to summon the appropriate healthcare provider that is listed on the client's account.

Preferably the system 11 receives 240 feedback from the client 20 concerning service providers 30 and stores the feedback 245 with the database module 70. Based on the feedback 240 from the client 20 and self-feedback 240 from the service provider, it is possible to redesign the jobs of the clients 20 to better suit the clients' needs and provide trainings to the service providers 30 to better fulfill the clients' needs. The system 11, once it receives the feedback 240, conducts an analysis 295 to determine whether to suggest career mapping and training suggestion and education suggestions 275 to the service provider 30. Once these suggestions 275 are generated, the system 11 generates an updated team 200 of service providers 30. The system 11 is also capable of creating a review process whereby the clients 20 review the service providers 30 and the service providers 30 review the clients 20. Upon completion of the services, the system 11 again requests 220 the acceptance or rejection of the service provider 30 by the client 20, and if receiving a rejection, replaces 225 the rejected service provider 30 with an alternate service provider 30. Feedback 245 of previous clients 20 utilizing a particular service provider 30, for example, can be displayed to clients 20 to allow the client 20 to consider such feedback 245 when making an acceptance or rejection decision concerning the service provider 30. When goals are achieved by the service providers 30, the system 11 pushes a notification to the clients 20 to alert them of the goals' achievement. External systems may be integrated with the system 11, particularly CRM platforms.

Optionally the system 11 connects 280 the client 20 with a customer service representative through the network 15 and server 40 daily, or at least regularly, to monitor progress and satisfaction of the client 20. Further, periodically the system 11 can again request 120 the client 20 to complete the questionnaire 125 to ascertain if any new needs are present or if there are needs that are no longer required by the client 20.

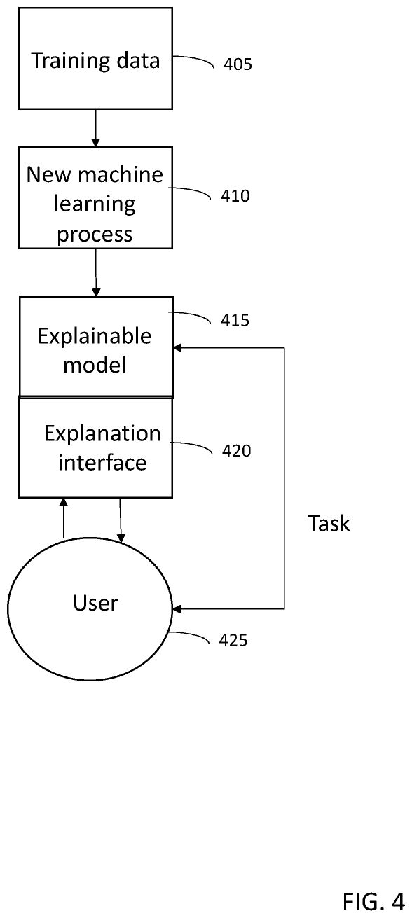

FIG. 4 is a schematic illustrating XAI. Training data 405 is inputted into the machine learning process 410, which trains the inputted data to provide iteratively improved output results. The explainable model 415, once applied to the output of the machine learning process 410, minimizes bias in the output by explaining the rationale of the system, characterizing the system's strengths and weaknesses, and conveying an understanding of how accurate future output will be. The explanation interface 420 provides a visual representation of the findings of the machine learning process 410 after application of the explainable model 415. In some embodiments, the explanation interface 420 is a user interface of a networked computing device, such as a smartphone, a computer, and the like. A user 425 has the ability to adjust the explainable model 415 when the accuracy of the match between the client and service provider is lower than desired by the user 425. Training data 405 in the system can take on many forms. The answers from the questionnaire is an example of training data, providing a match of clients 20 with service providers 30 once the data goes through the machine learning process 410 with the explainable model 415 applied to the data. The result of this action is a list of service providers 30, with percentages allocated to each service provider 30. The percentage indicates how suitable the service provider 30 is for the clients' job. The system 11 allows the user 425 to adjust the results by modifying questionnaire answers to increase the percentage. As more and more questionnaire answers are entered, the system 11 becomes better at suggesting service providers 30 for the clients' jobs. In addition to matching clients 20 and service providers 30, the system 11 has other aspects that use XAI. The background check 300 uses XAI, as data regarding the service providers may be inputted as training data 405 to go through the machine learning process 410, with the explainable model 415 applied to the data to output whether the service providers 30 pass a background check 300. As more and more data regarding the service providers 30 is accumulated by the system 11, more refined background checks 300 are possible. The system 11 is also capable of accepting data regarding service providers' education or certifications 260 as training data 405. This training data 405 goes through the machine learning process 410 with the explainable model 415 applied to it. As more and more information regarding service providers' 30 certifications 260 is gathered, better analysis of service providers' 30 credentials is possible and better recommendations for certifications 260 are possible. Training data 405 may also take the form of feedback 240 from the clients 20 and service providers 20. As more feedback 240 is accumulated, it is possible to generate more refined assignments of service providers 30 to clients 20. Information regarding the service providers 30 as training data 405 also allows the generation of particular trainings 270 for the service providers 30, trainings 270 that are sent to the service providers 30. As more and more data is acquired regarding the service providers 30, more and more relevant trainings 270 will be sent to the service providers 30. Trainings 270 may include blog posts, published articles, white papers, YouTube videos, and the like.

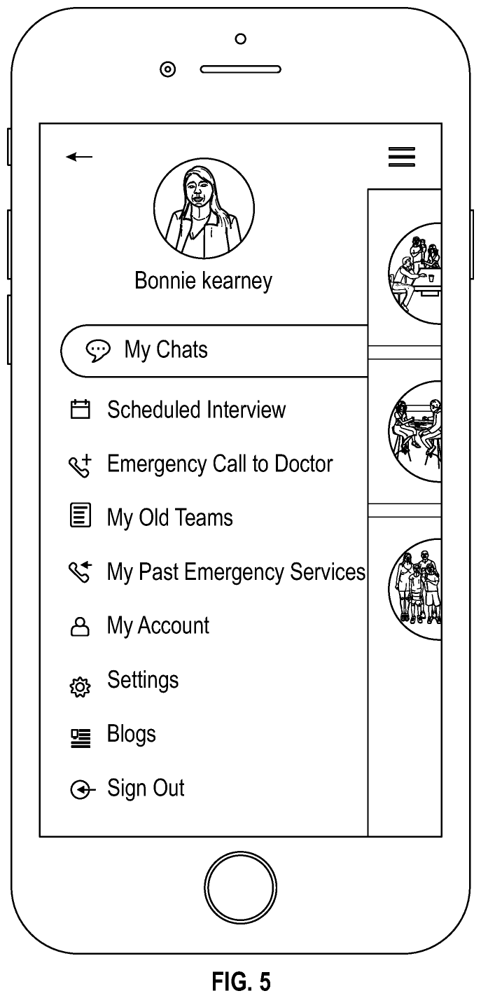

FIG. 5 is a depiction of the user interface of the system, as seen on a networked computing device. In this instance, it is the networked computing device of the client, as it shows client information. Also in this instance, the networked computing device is a smartphone.

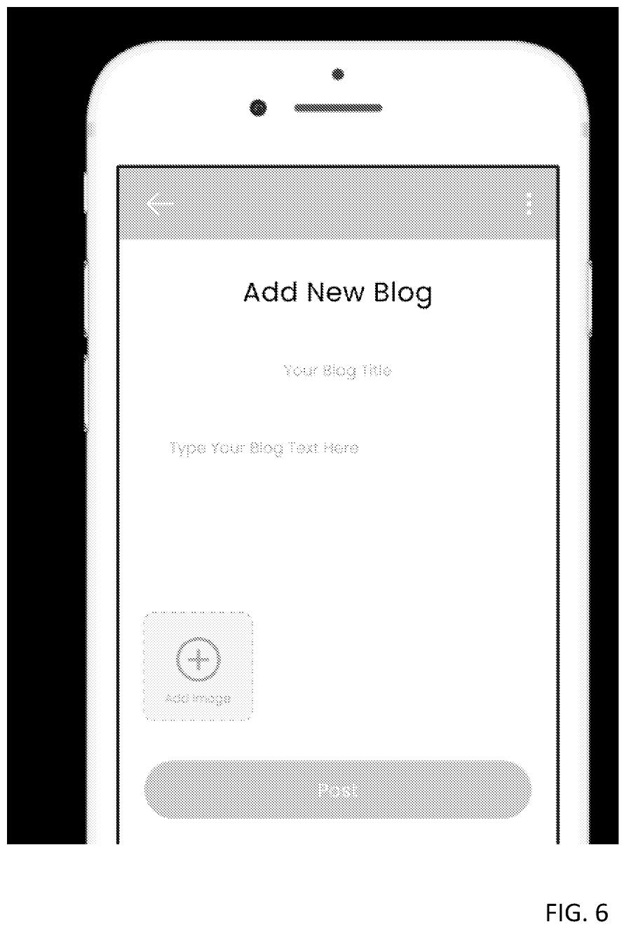

FIG. 6 is another depiction of a user interface of the system, seen on a similar networked computing device as shown in FIG. 5. In this instance, the networked computing device is a smartphone, although the networked computing device may be other than a smartphone.

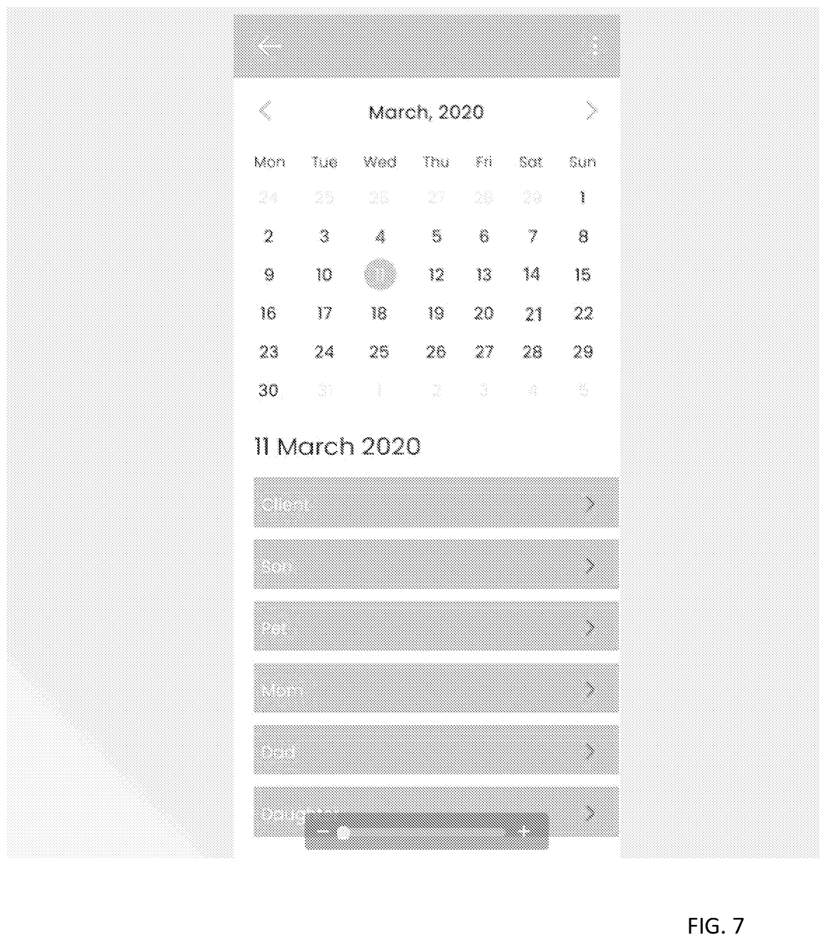

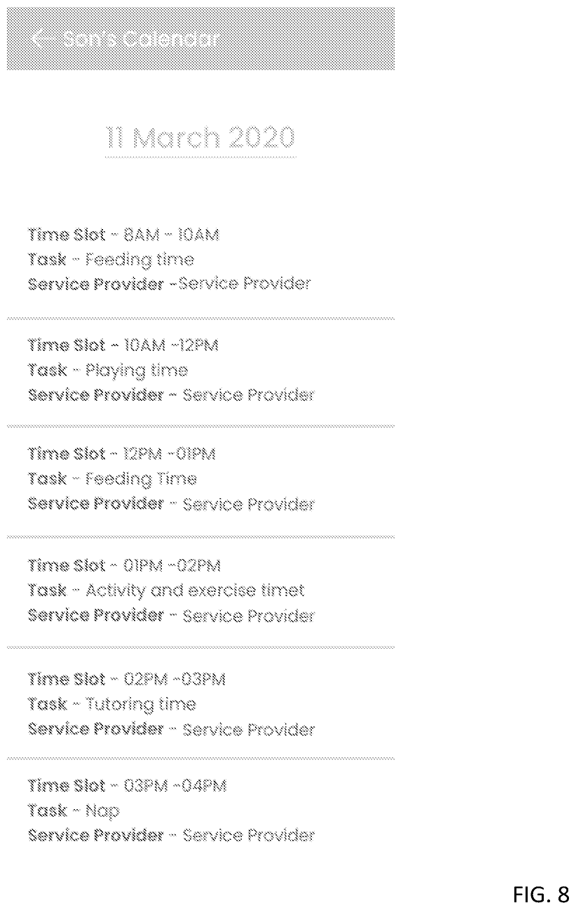

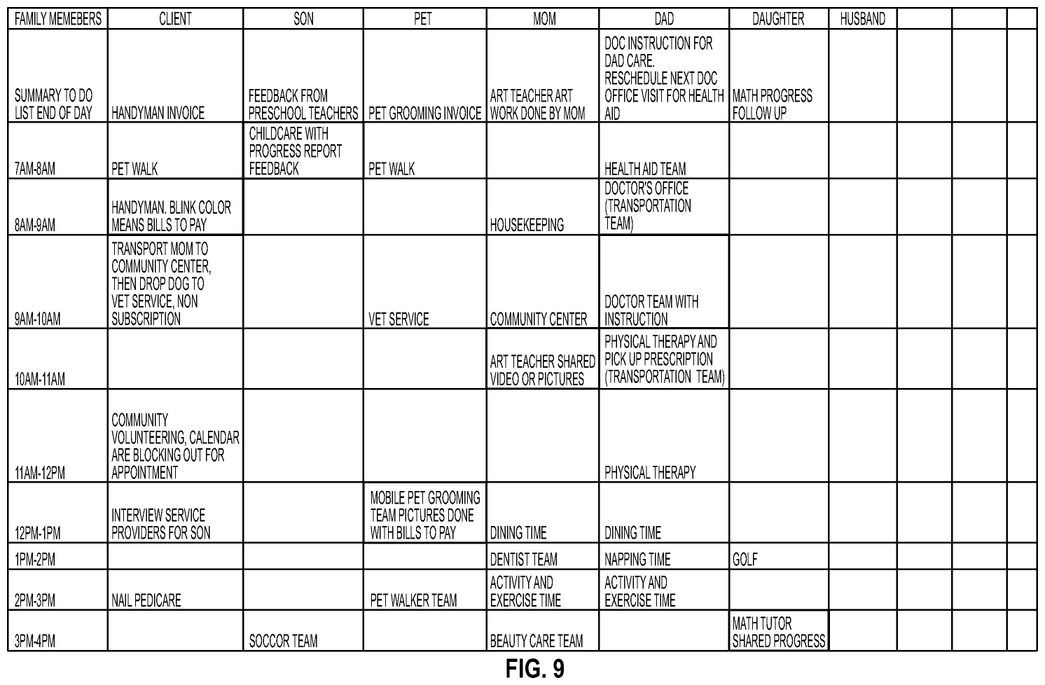

A client has a choice to see each household member's calendar on a particular date (in this instance Mar. 11, 2020 as seen in FIG. 7) by clicking a particular household member's button. FIG. 8 shows the outcome of clicking the son's button, showing the son's calendar detail. FIG. 9 shows the outcome of clicking the calendar date Mar. 11, 2020, which is a daily activity log of the client and other users affiliated with the client (son, daughter, mom, etc.). Clicking on items in FIG. 9 yields different outcomes. For instance, by clicking on “Handyman. Blink color means bills to pay”, an invoice appears on the user interface of the networked computing device. Clicking on “Childcare with progress report feedback”, the user sees photos and learning progress and feedback from teachers and helpers.

### Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

1. A computer-implemented system for matching at least one client with at least one service provider comprising:
a terminal for receiving input data further comprising
a processor;
a memory;
a database module; and
a network module;
an engine for data processing comprising a machine learning process that is trained to match the at least one client and the at least one service provider;
an explainable model that minimizes bias of the machine learning process; and
an explanation interface that shows output data comprising results of the machine learning process after application of the explainable model, offering a recommendation for matching the at least one client with the at least one provider.

2. The system of claim 1, wherein the network module connects a computing device associated with the at least one client and a computing device associated with the at least one service provider.

3. The system of claim 1, wherein the machine learning process accepts data from a client questionnaire.

4. The system of claim 3, wherein output data is at least one service provider based on the input data and application of the explainable model to the machine learning process, with data associated with the at least one service provider being sent to the at least one client.

5. The system of claim 4, wherein a match between the at least one client and the at least one service provider is gauged between 0% and 100%, with the match being a prediction of the machine learning process after application of the explainable model.

6. The system of claim 5, wherein the match is adjustable by feedback from a user.

7. The system of claim 1, further comprising a background check tool.

8. The system of claim 1, further comprising an interviewing tool.

9. The system of claim 1, further comprising a payment tool.

10. The system of claim 1, further comprising at least one of scheduling tool, a communications tool, and a texting tool.

11. The system of claim 1, further comprising at least one of a goal setting tool and a budget tool.

12. A method for matching at least one client with at least one service provider comprising:
providing a computer-implemented system that comprises a terminal for receiving input data, the system further comprising
a processor;
a memory;
a database module; and
a network module;
an engine for data processing comprising a machine learning process that is trained to match the at least one client and the at least one service provider;
an explainable model that minimizes bias of the machine learning process; and
an explanation interface that shows output data comprising results of the machine learning process after application of the explainable model, offering a recommendation for matching the at least one client with the at least one provider.
inputting input data from the at least one client;
receiving a match with at least one service provider; and
refining the match based on further training of the input data.

13. The method of claim 12, wherein the input data is information from a client questionnaire.

14. The method of claim 12, wherein the network module connects a computing device associated with the at least one client and a computing device associated with the at least one service provider.

15. The method of claim 12, wherein the match between the at least one client and the at least one service provider is gauged between 0% and 100%, with the match being a prediction of the machine learning process after application of the explainable model.

16. The method of claim 12, wherein the match is adjustable by feedback from a user.

17. The method of claim 12, further comprising a background check tool.

18. The system of claim 12, further comprising an interviewing tool.

19. The system of claim 12, further comprising a payment tool.

20. The system of claim 12, further comprising at least one of a scheduling tool, a communications tool, and a texting tool, a goal setting tool, and a budget tool.

21. (canceled)
